(19) United States
(12) Patent Application Publication
(10) Pub. No.: US 2026/0063255 A1
(43) Pub. Date: Mar. 5, 2026

(54) LUMINOUS POWER CABLE PROVIDED WITH SOCKET

(71) Applicants: Guosheng LIU, Guangdong Province (CN); Xiaonong DING, Guangdong Province (CN)

(72) Inventors: Guosheng LIU, Guangdong Province (CN); Xiaonong DING, Guangdong Province (CN)

(21) Appl. No.: 18/923,668

(22) Filed: Oct. 22, 2024

(30) Foreign Application Priority Data
Aug. 29, 2024 (CN) 2024221077017

(51) Int. Cl. F21S 4/24; F21V 23/00; F21V 23/04; F21V 23/06

(52) U.S. Cl. CPC F21S 4/24; F21V 23/001; F21V 23/003; F21V 23/04; F21V 23/06

(57) ABSTRACT

The invention relates to the technical field of power cables, in particular to a luminous power cable provided with a socket, comprising an LED luminous connecting wire, a power plug, a socket and a control assembly, wherein two ends of the LED luminous connecting wire are connected to the power plug and the socket respectively, and the control assembly is mounted on the power socket and connected to the LED luminous connecting wire. The luminous power cable is simple in structure and reasonable in design; the power plug and the socket are connected by means of the LED luminous connecting wire to realize 360° LED lighting; and the luminous power cable not only can be used for lighting, but also can be used for supplying power by means of the power socket, thus better satisfying application requirements.

### TECHNICAL FIELD

The invention relates to the technical field of power cables, in particular to a luminous power cable provided with a socket.

### BACKGROUND OF THE INVENTION

In a smart home system, a luminous power cable provided with a socket, as the combination of a smart socket and a night lamp, not only can supply power to other smart equipment, but also can provide soft light at night to satisfy the requirements for convenience and comfort of users. For example, when applied to business places such as markets, shops and restaurants, the luminous power cable provided with a socket can be used for supplying power, decoration and lighting; when applied to public places such as airports, railway stations and subway stations, the luminous power cable provided with a socket can be used for indicating the position of a power socket to improve the convenience in use; or, the luminous power cable provided with a socket can be used outdoors for emergency lighting or creative individualized use to fulfill a better application effect.

Most luminous power cables in prior art emit light by means of self-luminous materials or some individual lamp beads, but they cannot realize a 360° lighting effect and thus cannot satisfy the corresponding application requirement.

In view of this, the application aims to provide a luminous power cable provided with a socket to solve the abovementioned technical problem.

### BRIEF SUMMARY OF THE INVENTION

To solve the abovementioned problem, the invention provides a luminous power cable provided with a socket, which realizes 360° LED lighting of a power cable by means of an LED light strip wound around the power cable, such that the luminous power cable not only can be used for lighting, but also can be used for supplying power by means of a power socket.

The technical solution adopted by the invention is as follows:

A luminous power cable provided with a socket comprises an LED luminous connecting wire, a power plug, a socket and a control assembly, wherein two ends of the LED luminous connecting wire are connected to the power plug and the socket respectively, and the control assembly is mounted on the power socket and connected to the LED luminous connecting wire.

Further, the LED luminous connecting wire is provided with an LED light strip and a power cable, the LED light strip is wound around the power cable, and the LED light strip and the power cable are respectively connected to the power plug, the socket and the control assembly.

Further, the power cable comprises a wire harness formed by a lead wire and a ground wire, and a jacket, the LED light strip is wound around the wire harness, and the LED light strip is wrapped in the jacket.

Further, the LED light strip is flat.

Further, the jacket is a light-transmitting jacket.

Further, the LED light strip is a colored LED light strip.

Further, the control assembly is provided with a switch control unit and an LED lighting control unit, the switch control unit is connected to the power cable, and the LED lighting control unit is connected to the LED light strip.

Further, the LED lighting control unit is provided with a lighting color, brightness and position control module.

The invention has the following beneficial effects:

The luminous power cable provided with a socket comprises an LED luminous connecting wire, a power plug, a socket and a control assembly, two ends of the LED luminous connecting wire are connected to the power plug and the socket respectively, and the control assembly is mounted on the power socket and connected to the LED luminous connecting wire; the luminous power cable is simple in structure and reasonable in design; the power plug and the socket are connected by means of the LED luminous connecting wire to realize 360° LED lighting; and the luminous power cable not only can be used for lighting, but also can be used for supplying power by means of the power socket, thus better satisfying application requirements.

### BRIEF DESCRIPTION OF THE DRAWINGS

FIG. 1 is an exploded structural view according to some embodiments of the application;

FIG. 2 is a schematic structural view according to some embodiments of the application.

### REFERENCE SIGNS

1, LED luminous connecting wire; 11, LED light strip; 12, power cable; 121, lead wire; 122, ground wire; 123, jacket; 2, power plug; 3, socket; 4, control assembly.

### DETAILED DESCRIPTION OF THE INVENTION

The technical solution of the invention will be clearly and completely described below in conjunction with accompanying drawings. Obviously, the embodiments in the following description are merely illustrative ones, and are not all possible ones of the invention. All other embodiments obtained by those skilled in the based on the following ones without creative labor should also fall within the protection scope of the invention.

In the description of the invention, it should be noted that terms “upper”, “lower”, “left”, “right”, “vertical”, “horizontal”, “inner”, “outer”, “front” and “back” are used to indicate directional or positional relations based on the accompanying drawings merely for the purpose of facilitating and simplifying the invention, do not indicate or imply that devices or elements referred to must be in a specific direction or configured and operated in a specific direction, and thus should not be construed as limitations of the invention.

In the description of the invention, it should be noted that unless otherwise expressly specified and stated, terms “mount”, “link” and “connect” should be broadly understood. For example, “connect” may refer to fixed connection, detachable connection or integrated connection; or, mechanical connection, direct connection, or indirect connection by means of an intermediate medium. Those skilled in the art can appreciate the specific meanings of these terms in the invention as the case may be.

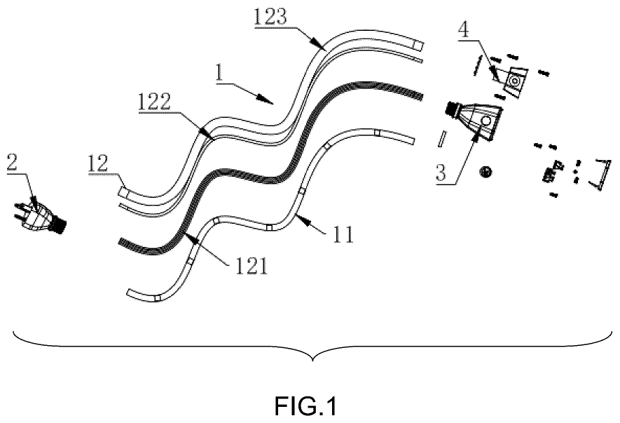

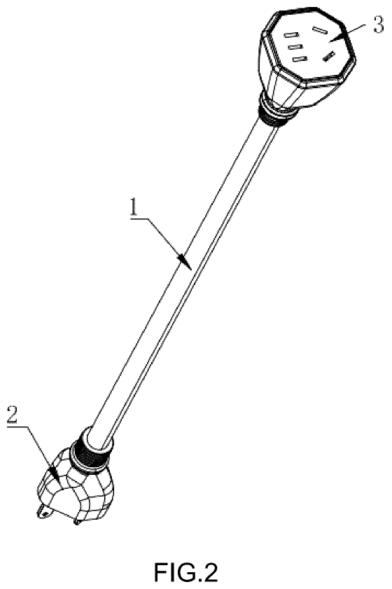

As shown in FIGS. 1-2, this embodiment provides a luminous power cable provided with a socket, comprising an LED luminous connecting wire 1, a power plug 2, a socket 3 and a control assembly 4, wherein two ends of the LED luminous connecting wire 1 are connected to the power plug 2 and the socket 3 respectively, and the control assembly 4 is mounted on the power socket 3 and connected to the LED luminous connecting wire 1.

The luminous power cable provided with a socket in this embodiment is simple in structure and reasonable in design; the power plug 2 and the socket 3 are connected by means of the LED luminous connecting wire 1 to realize 360° LED lighting; and the luminous power cable not only can be used for lighting, but also can be used for supplying power by means of the power socket 3, thus better satisfying application requirements.

In some specific embodiments, the LED luminous connecting wire 1 is provided with an LED light strip 11 and a power cable 12, the LED light strip 11 is wound around the power cable 12, and the LED light strip 11 and the power cable 12 are respectively connected to the power plug 2, the socket 3 and the control assembly 4.

Specifically, in this embodiment, the LED luminous connecting wire 1 is formed by the power cable 12 and the LED light strip 11 wound around the power cable 12, thus ensuring 360° LED lighting around the power cable 12; moreover, the LED light strip 11 is connected to the power plug 2 and emits light after being powered on, thus ensuring the brightness and effect of light emitted by the LED light strip 11.

In this embodiment, the power cable 12 specifically comprises a wire harness formed by a lead wire 121 and a ground wire 122, and a jacket 123, the LED light strip 11 is wound around the wire harness, and the LED light strip 11 is wrapped in the jacket 123.

In this embodiment, the composition of the power cable and the connection and arrangement of the power cable 12 and the LED light strip 11 are specifically illustrated, the structure is simple and compact, and a better 360° lighting effect is realized.

Specifically, in this embodiment, the LED light strip 11 is flat.

In this embodiment, the flat LED light strip 11 not only can be stably wound around and connected to the power cable 12, but also has a larger luminous area, thus fulfilling a better lighting effect.

Specifically, in this embodiment, the jacket 123 is a light-transmitting jacket 123.

In this embodiment, because the LED light strip 11 is wrapped in the jacket 123, the jacket 123 is designed into a light-transmitting jacket 123, such as a transparent jacket, to ensure that light emitted by the LED light strip 11 can be smoothly transmitted out of the jacket 123 to fulfill a better lighting effect.

In some embodiments, the LED light strip 11 is a colored LED light strip 11.

In this embodiment, the LED light strip 11 is designed into a colored LED light strip 11, and the color of light emitted by the LED light strip 11 can be adjusted by means of the control assembly 4 according to actual use and lighting requirements, so as to fulfill a better lighting effect.

In some embodiments, the control assembly 4 is provided with a switch control unit and an LED lighting control unit, wherein the switch control unit is connected to the power cable 12, and the LED lighting control unit is connected to the LED light strip 11.

Specifically, the LED lighting control unit is provided with a lighting color, brightness and position control module.

In this embodiment, the control assembly 4 is specifically provided with a switch control unit and an LED lighting control unit, thus realizing flexible control in use.

The above embodiments are merely several specific ones of the invention and are described in detail, but they should not be construed as limitations of the patent scope of the invention. It should be pointed out that those skilled in the art can make some transformations and improvements without departing from the concept of the invention, and all these transformations and improvements should also fall within the protection scope of the invention. Therefore, the protection scope of the invention should be defined by the appended claims.

What is claimed is:

1. A luminous power cable provided with a socket, comprising an LED luminous connecting wire, a power plug, a socket and a control assembly, wherein two ends of the LED luminous connecting wire are connected to the power plug and the socket respectively, and the control assembly is mounted on the power socket and connected to the LED luminous connecting wire.

2. The luminous power cable provided with a socket according to claim 1, wherein the LED luminous connecting wire is provided with an LED light strip and a power cable, the LED light strip is wound around the power cable, and the LED light strip and the power cable are respectively connected to the power plug, the socket and the control assembly.

3. The luminous power cable provided with a socket according to claim 2, wherein the power cable comprises a wire harness formed by a lead wire and a ground wire, and a jacket, the LED light strip is wound around the wire harness, and the LED light strip is wrapped in the jacket.

4. The luminous power cable provided with a socket according to claim 3, wherein the LED light strip is flat.

5. The luminous power cable provided with a socket according to claim 3, wherein the jacket is a light-transmitting jacket.

6. The luminous power cable provided with a socket according to claim 3, wherein the LED light strip is a colored LED light strip.

7. The luminous power cable provided with a socket according to claim 6, wherein the control assembly is provided with a switch control unit and an LED lighting control unit, the switch control unit is connected to the power cable, and the LED lighting control unit is connected to the LED light strip.

8. The luminous power cable provided with a socket according to claim 7, wherein the LED lighting control unit is provided with a lighting color, brightness and position control module.
